(19) United States
(12) Patent Application Publication
(10) Pub. No.: US 2026/0023606 A1
(43) Pub. Date: Jan. 22, 2026

(54) SYNCHRONIZATION OF CONFIGURATION SETTINGS IN DISTRIBUTED COMPUTING SYSTEMS

(71) Applicant: Sedai Inc., Pleasanton, CA (US)

(72) Inventors: Nikhil Gopinath Kurup, Tampa, FL (US); Mathew Koshy Karunattu, Pleasanton, CA (US); Suresh Mathew, San Ramon, CA (US); Hari Chandrasekhar, Highlands Ranch, CO (US); Benjamin Thomas, San Jose, CA (US); Ethan Andyshak, Portland, OR (US)

(73) Assignee: Sedai Inc., Pleasanton, CA (US)

(21) Appl. No.: 19/339,086

(22) Filed: Sep. 24, 2025

Related U.S. Application Data
(63) Continuation-in-part of application No. 18/131,004, filed on Apr. 5, 2023.
Application No. 18/131,004 is a continuation-in-part of application No. 17/678,907, filed on Feb. 23, 2022, now Pat. No. 11,900,162.
Application No. 17/678,907 is a division of application No. 17/387,984, filed on Jul. 28, 2021, now Pat. No. 11,294,723.
(60) Provisional application No. 63/214,783, filed on Jun. 25, 2021.
(60) Provisional application No. 63/214,784, filed on Jun. 25, 2021.
(60) Provisional application No. 63/698,707, filed on Sep. 25, 2024.

(51) Int. Cl. G06F 9/50; G06F 8/71; G06F 11/07; G06F 11/30; G06F 11/34; G06N 3/08; G08B 21/18; H04L 43/16; H04L 67/00; H04L 67/10

(52) U.S. Cl. CPC G06F 9/5016; G06F 8/71; G06F 9/5094; G06F 11/0721; G06F 11/0769; G06F 11/079; G06F 11/3006; G06F 11/34; G06F 11/3452; G06N 3/08; G08B 21/182; H04L 43/16; H04L 67/10; H04L 67/34; G06F 2209/501

(57) ABSTRACT

Implementations described herein relate to methods, systems, and computer-readable media to synchronize configuration settings. In some implementations, a method may include performing an optimization of one or more computing resources in a distributed computing system, determining, based on the optimization, that a setting of at least one computing resource is to be adjusted, determining that performing an adjustment to the at least one computing resource would cause a mismatch between a setting for the at least one computing resource in the distributed computing system and a corresponding setting stored in a version control repository for the at least one computing resource, generating an updated configuration file, wherein the update configuration file is indicative of an adjusted setting for the at least one computing resource, and transmitting a request to a version control system to add the updated configuration file to the version control repository.

### CROSS-REFERENCE TO RELATED APPLICATIONS

This application additionally claims priority to U.S. Provisional Patent Application No. 63/698,707, filed 25 Sep. 2024, titled “SYNCHRONIZATION OF CONFIGURATION SETTINGS IN DISTRIBUTED COMPUTING SYSTEMS.” This application is additionally a continuation in part of U.S. patent application Ser. No. 18/131,004, filed 5 Apr. 2023, titled “PERFORMANCE PROTECTED AUTONOMOUS APPLICATION MANAGEMENT FOR DISTRIBUTED COMPUTING SYSTEMS,” which is a continuation in part of U.S. patent application Ser. No. 17/678,907, filed 23 Feb. 2022, titled “AUTONOMOUS APPLICATION MANAGEMENT FOR DISTRIBUTED COMPUTING SYSTEMS,” now U.S. Pat. No. 11,900,162, which is a divisional application of U.S. patent application Ser. No. 17/387,984, filed 28 Jul. 2021, titled “AUTONOMOUS APPLICATION MANAGEMENT FOR DISTRIBUTED COMPUTING SYSTEMS”, now U.S. Pat. No. 11,294,723, which claims priority to U.S. Provisional Patent Application No. 63/214,783, filed 25 Jun. 2021, titled “AUTONOMOUS MANAGEMENT OF COMPUTING SYSTEMS” and to U.S. Provisional Patent Application No. 63/214,784, filed 25 Jun. 2021, titled “CLOUD MANAGEMENT SYSTEM WITH AUTONOMOUS ABERRANT BEHAVIOR DETECTION.” All of the above listed applications are incorporated by reference herein in their entirety.

### TECHNICAL FIELD

Embodiments relate generally to synchronization of real-time configuration setting changes in software applications in distributed computing systems with Infrastructure as Code (IaC) settings.

### BACKGROUND

Some computer systems utilize distributed architectures, e.g., cloud based systems to host applications. The applications may be hosted across multiple computer systems that are operated by different service providers, and in many cases, using a variety of computing devices.

Modern software development commonly follows a continuous integration and continuous delivery/continuous deployment (CI/CD) methodology, in which incremental code changes are made frequently, often by small teams and released for deployment after testing using a suitable test deployment. Infrastructure as Code (IaC) systems are commonly utilized to implement code based configuration settings. However, when configuration settings are changed during runtime, the settings may be out of synchronization with the IaC settings.

IaC management platforms may be utilized to detect drift but are commonly configured to automatically trigger a command to revert the infrastructure to the state defined in a version control repository. They may be able to correct drift but cannot usually distinguish between a mistake and a beneficial optimization. Tools may be utilized to continuously monitor the live environment and immediately undo any change not originating from an IaC commit. They are explicitly designed to nullify out-of-band changes, making them hostile to external optimization engines.

Policy-as-Code tools may be utilized to act as preventative gates in the code development pipeline, blocking non-compliant changes before they are deployed. They can prevent bad configurations but offer no mechanism to approve and incorporate optimized configurations that are determined in real-time.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

One general aspect includes a method to synchronize configuration settings. In some implementations, a computer-implemented method may include performing an optimization of one or more computing resources in a distributed computing system, determining, based on the optimization, that a setting of at least one computing resource is to be adjusted, determining that performing an adjustment to the at least one computing resource would cause a mismatch between a setting for the at least one computing resource in the distributed computing system and a corresponding setting stored in a version control repository for the at least one computing resource, generating an updated configuration file, wherein the update configuration file is indicative of an adjusted setting for the at least one computing resource, and transmitting a request to a version control system to add the updated configuration file to the version control repository.

In some implementations, the computer-implemented method may further include verifying that the adjusted setting for the at least one computing resource lies within a corresponding range of values for the at least one computing resource included in a guardrail configuration file.

In some implementations, the computer-implemented method may further include determining that there is no defined range of values for the one or more computing resources included within the version control repository, and providing a user interface to enable a user to generate the range of values for the one or more computing resources for inclusion in a guardrail configuration file.

In some implementations, the computer-implemented method may further include determining that there is no defined range of values for the one or more computing resources included within the version control repository, calculating a range of values for the one or more computing resources, and transmitting the range of values to the version control system for inclusion in a guardrail configuration file within the version control repository.

In some implementations, the distributed computing system is configured using a container orchestration system. In some implementations, the updated configuration file is a patch file that includes one or more environment specific transformers and generators that can be utilized to modify resources associated with each environment in the distributed computing system.

In some implementations, the distributed computing system is configured using a cloud infrastructure provisioning system. In some implementations, the updated configuration file is operable to modify an override file that can be utilized to redeclare the at least one computing resource with an adjusted setting.

In some implementations, the computer-implemented method may further include merging the updated configuration file into the version control repository. In some implementations, the computer-implemented method may further include applying updated configuration settings to the distributed computing system.

In some implementations, a computer-implemented method may include receiving, at a version control system, a request from an autonomous cloud resource management system, wherein the request includes an updated configuration file that includes one or more updated configuration settings for a distributed computing system, and merging the updated configuration file included in the request into a version control repository, wherein the version control repository includes a guardrail configuration file, and wherein the updated configuration file included in the request includes a setting for a resource attribute associated with one at least one computing resource that lies within specified values included in the guardrail configuration file.

In some implementations, the computer-implemented method may further include generating the guardrail configuration file. In some implementations, generating the guardrail configuration file may include generating the guardrail configuration file based on suggested values received from the autonomous cloud resource management system.

In some implementations, the updated configuration file is operable to modify an override file that can be utilized to redeclare the at least one computing resource with an adjusted setting included in the one or more updated configuration settings. In some implementations, the updated configuration file is a patch file that includes one or more environment specific transformers and generators that can be utilized to modify resources associated with each environment in the distributed computing system.

In some implementations, the computer-implemented method may further include applying the updated configuration file to the distributed computing system.

In some implementations, a system for integrating autonomous computing resource optimization with Infrastructure-as-Code (IaC) workflows may include an optimization engine configured to autonomously optimize computing resources in a live environment and to determine updated configuration settings for the live environment, and a reconciliation module configured to: detect a mismatch between a live environment configuration and a configuration defined in a version control repository resulting from the autonomous optimization, and generate a request to the version control repository, the request including an additive configuration file that reflects the updated configuration settings.

In some implementations, the live environment is a cluster of containers, and wherein the additive configuration file is a configuration patch file. In some implementations, the system may further include a custom provider configured to map resource addresses to corresponding cloud resource identifiers (IDs) and securely transmit the map to the system. In some implementations, the reconciliation module is configured to generate the request with an override file that redeclares the optimized resource with new attribute values.

Implementations of the described techniques may include hardware, a method or process, or computer software on a computer-accessible medium.

### BRIEF DESCRIPTION OF THE DRAWINGS

FIG. 1 is a diagram of an example distributed computing environment, in accordance with some implementations.

FIG. 2 illustrates a cloud management system, in accordance with some implementations.

FIG. 3A is a diagram that depicts an example of a cloud management system and example interacting systems, in accordance with some implementations.

FIG. 3B depicts an example architecture for the synchronization of configuration settings, in accordance with some implementations.

FIG. 4A depicts an example implementation of a serverless function in a distributed (cloud) computing environment, in accordance with some implementations.

FIG. 4B depicts an example topology within a distributed (cloud) computing environment, in accordance with some implementations.

FIG. 4C depicts an example performance metric record utilized in monitoring a distributed computing system, in accordance with some implementations.

FIG. 5A is a flowchart illustrating an example method to synchronize configuration settings in an IaC environment, in accordance with some implementations.

FIG. 5B is a flowchart that illustrates an example method to synchronize configuration settings (optimal resource allocation setpoints), in accordance with some implementations.

FIG. 5C is a flowchart that illustrates another example method to synchronize configuration settings (optimal resource allocation setpoints), in accordance with some implementations.

FIG. 6 is a block diagram that depicts an example implementation of an alert engine (minion) and interacting components, in accordance with some implementations.

FIG. 7 is a block diagram illustrating IaC synchronization, in accordance with some implementations.

FIG. 8 depicts example detection of outliers, in accordance with some implementations.

FIG. 9 is a block diagram that depicts determination of a load based anomaly detection score, in accordance with some implementations.

FIG. 10A-B depicts example screenshots of IaC synchronization, in accordance with some implementations.

FIG. 10C depicts an example configuration file that includes a specification of ranges of values for computing attributes, in accordance with some implementations.

FIG. 11 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

Today's extremely competitive global market calls for a high degree of business agility and responsiveness to customer needs and tastes. The introduction rate of new features via software releases has steadily increased to meet ever-evolving customer needs, and innovative computing architectures such as cloud native microservice architectures are becoming the new norm. Releases have risen to hundreds per month with a consequent impact on the roles and responsibilities of Site Reliability Engineers (SRE) who are tasked with managing the computing environment.

Technical outages to computing systems can have significant business implications. For example, Costco warehouse, with over 98.6 million members, had one of its biggest outages on Thanksgiving Day in 2019, impacting close to 2.6 million of its customers and causing more than $11 million in losses. On the same day, Home Depot, H&M, and Nordstrom customers too reported issues with their e-commerce sites. According to the Information Technology Industry Council (ITIC), 86% of the companies estimate that an hour of downtime can cause a greater than $300,000 revenue loss, and for 34% of companies, anywhere from $1 to $5 million.

RetailTouchPoints reported that for Black Friday shoppers specifically, nearly half of consumers (49%) say they will abandon their cart if they receive any error message during checkout that prevents them from completing their purchase. Shoppers who have to wait six seconds are 50% less likely to make a purchase, and 33% of shoppers will visit a competitor if the site they are currently on is slow to load.

For more critical services like health care, the stakes are much higher. Dexcom, a leader in continuous glucose monitoring systems, had a service outage for more than 24 hours, which resulted in irate customers and lives at risk.

With businesses increasingly earning larger revenue shares from online commerce, CTOs and SRE organizations are under tremendous pressure to achieve high levels of site availability at the most optimal costs-all while satisfying ever-increasing regulatory pressures.

In the pre-DevOps/Cloud era, monolithic services designed site architectures for product and software releases once or twice a year. However, businesses' modern needs now dictate faster responses to market signals. With the advent of cloud technology and simultaneous services segmentation, product features can be released quicker than ever-sometimes more than 50 times per year. But alongside an increased churn rate for features and versions comes elevated management costs.

Cloud adoption, virtualization, and DevOps maturity have led to agile deployment strategies and reduced time to market (TTM), which allows businesses to compete more effectively. Automation played a vital role on the road to achieving agile deployment-processes transitioned from being imperatively managed by a set of system administrators with command line interface, to being declaratively managed by a much smaller team of administrators in a distributed framework.

Organizations commonly utilize multiple cloud providers to implement their computing solutions. For example, an organization may utilize offerings from one or more providers, e.g., Amazon Web Services (AWS), Google Cloud Platform (GCP), Microsoft Azure etc., to implement their solution architecture. Metrics associated with their solution architecture and applications running over their architecture may be provided by multiple monitoring providers.

A typical software product implemented via a microservices based architecture may include hundreds of underlying applications. For example, a money transfer application may include multiple microservices operating using a combination of parallel and sequential processes, e.g., a client login microservice, a pre-validation check microservice, a microservice that performs funds availability verification, a risk analysis microservice to investigate fraud or other unauthorized transaction, etc.

Each microservice may be executed by a different codeset, implemented and managed by different teams, with their own development cycles, releases, etc. Each of the microservices may utilize its own metric or set of metrics to monitor performance and health of the microservice and/or application.

During run-time, issues and problems may occur at any of multiple levels, e.g., runtime errors or performance issues caused by code issues due to a new release, integration issues of a particular microservice with other microservices, integration issues with third party providers, network issues, hardware issues, etc.

Anomalies and/or problems observed in distributed computing systems can be roughly divided into three categories: Early Failures, Random Failures, and Late Failures. The increased pace of software development, and a higher frequency of releases of software applications, e.g., using an Agile or other development framework, leads to an increase in Early Failures. happen as a side effect of the velocity of innovation, such as the newness of an application. When an application starts to mature, the frequency of failures goes down. Techniques of this disclosure can mitigate early failures by automatically analyzing new releases in the production environment, before the effects spread widely through a distributed computing system. Predictive scaling of new releases of software applications is performed based on early and intelligence release analysis.

This disclosure describes a cloud management platform to autonomously monitor distributed computer systems and their input metric settings, detect abnormal system behavior and anomalies, and autonomously generate alerts and recommendations. In some implementations, autonomous remediation may be undertaken by the cloud management platform.

Unlike traditional remediation techniques and run book automation platforms that provide threshold based automation, advanced machine learning techniques are utilized herein to detect issues with an application centric approach. The cloud management platform can integrate with various Cloud/PaaS providers and can auto detect (infer) an application topology with minimal user intervention. Integration with multiple monitoring providers is enabled and the metric data obtained can be overlaid on the inferred application topology. Application behavior is continually monitored and clustering techniques (e.g., self correcting bounded clustering) may be utilized to identify misbehaving instances.

Another limitation commonly encountered with monitoring providers is collection delay. Monitoring providers commonly provide metric data that includes a data collection delay, e.g., a 15-20 minutes data collection delay, which effectively leads to delayed detection of aberrant (abnormal) application behavior. For example, problems may be brought to notice of SREs after the collection delay. Per techniques of this disclosure, machine learning models are utilized to learn application behavior over time. The ML model(s) can be utilized to predict a current (estimated) state of one or more applications and thereby compensate for missing data due to the collection delay.

Autonomous system characteristics in a cloud context are incorporated into the cloud management platform which utilizes an influx of data streams, e.g., time-series data of metrics, to build a layer of intelligence via a core decision engine that utilizes probability theory and applies machine learning techniques. The cloud management platform is self-learning and utilizes a self-correcting model to seamlessly manage cloud platforms with a focus on explainable decisions.

An autonomous cloud platform can improve performance, cost, and availability for cloud applications. Customers can achieve up to 53% cost savings, 30% latency reductions, and 33% reduction in SRE workload. Through machine learning, the platform intelligently manages production environments without manual thresholds or human intervention. The cloud management platform can independently detect, prioritize, and analyze performance metrics to identify opportunities to safely act in production on an SRE's behalf.

The platform is designed to save cloud teams time by shifting workflows to modern ML-based autonomous operations, which is continuously refined by adapting to ongoing microservice changes and learning from previous optimizations.

Abnormal and aberrant (anomalous) behavior of applications may arise from specific anomalous instances, errors in the application codebase, network issues, etc. Per techniques of this disclosure, a trained ML model is utilized to analyze application level problems and instance level problems and provide a recommendation based on identification of a problem source.

A two-tiered approach is utilized, whereby an alert engine generates signals and/or scores based on identification of instance-level and application-level outlets from the monitored metrics for each configured application being monitored. The generated signals and/or scores are then provided to a core decision engine, which utilizes additional historical data and feedback from previously provided recommendations and/or actions to provide recommendations for a current scenario.

In some implementations, a cloud management platform (system) may also be utilized to determine optimal operating points for a cloud based implementation of a distributed computing system, and to generate recommendations for resource allocation during utilization of the distributed computing systems. During optimization of configuration settings, one or more configuration settings (parameters) may be adjusted (changed) at runtime for better performance, etc.

In some implementations, machine learning techniques may be utilized to assess client computing system topology, resource allocation settings, and performance metrics to proactively recommend operating settings for one or more computing resources to ensure that software applications remain highly efficient, secure, available, and cost-effective.

For example, in the case of a serverless computing implementation, e.g. Lambda instances, a recommendations feature of the cloud management platform, would automatically identify under-utilized memory within the implementations and may recommend a proactive scale down of the memory allocated to a software application (function).

Similarly, in a distributed computing system that includes a cluster, optimization may be performed to improve performance, reduce costs, and enhance resource utilization within the environment. This can include determining optimal values for CPU and memory requests and limits for pods based on actual usage patterns. This prevents over-provisioning (wasting resources) and under-provisioning (leading to performance issues). In some implementations, resource requests and limits for individual pods may be adjusted based on their historical and real-time usage, ensuring optimal resource allocation.

In some implementations, the number of pod replicas may be scaled up or down based on metrics like CPU utilization or custom metrics, ensuring applications can handle varying loads efficiently. In some implementations, a number of nodes in the cluster may be adjusted based on pending pods and resource availability, ensuring efficient use of compute resources and reducing costs during periods of low demand.

In some implementations, optimization and management of resource allocation may be based on benchmarking of the distributed computing system using a known software application, e.g., a test function. In a typical distributed computing set up, a customer user selects a memory allocation setting for their application, which comes with a certain cost for operation, e.g., higher memory allocation incurs a greater cost per unit of time that the computing resources are utilized. At the same time, a higher memory allocation may enable a software application to execute in a smaller amount of time, which may more than compensate for the greater unit cost. An amount of CPU power may also be specified by the customer user, though in many cases, the CPU allocation may automatically be based on the selected memory allocation setting and be opaque to the customer.

Doubling a memory allocation setting may have an unpredictable impact on a time of execution, a user experience metric, or any one of numerous metrics that are critical from a business perspective. Conservatively selecting a high memory setting may incur unnecessary costs. A technical problem in the software arts is an optimal selection of a computing resource allocation setting, e.g., memory, for a given software application and/or infrastructure provider.

Per techniques of this disclosure, for a given implementation of a distributed computing system such as a serverless system, an optimal memory allocation setting (setpoint) is determined for a software application (function) that is to be executed in the distributed computing system. In some implementations, an optimal memory allocation or other computing resource setting may be determined for each function taking into account performance requirements, service level objectives (SLO), and cost considerations.

However, autonomous management of a distributed computing system and applying the optimal resource allocation settings poses additional technical challenges. Modern cloud operations of computing systems are typically driven by two competing goals: maintaining strict control through Infrastructure-as-Code (IaC) and achieving efficiency through autonomous optimization.

In some scenarios, utilization of an Infrastructure-as-Code (IaC) approach includes a practice of managing infrastructure (servers, databases, networks, etc.) through version-controlled code, with a version control repository, e.g., a Git repository, serving as a single source of truth. Tools, e.g., Terraform, Helm, Ansible, Pulumi, CloudFormation, Azure Resource Manager (ARM) templates, Google Cloud Deployment Manager, Chef, Puppet, SaltStack, Crossplane, etc., may be utilized to enforce this, ensuring consistency and auditability. In today's cloud setups, companies use Infrastructure as Code (IaC) to maintain their infrastructure, with IaC serving as the primary reference point for the configurations of various cloud resources. However, cloud management systems that apply optimized resource configurations can lead to differences between managed configurations and those laid out in IaC scripts.

In some implementations, a tool may be utilized to direct changes of resource allocation settings, and any settings in the live environment that do not match the settings specified in the code in the repository is considered to be “drift.”

In some implementations, efficiency of a distributed computed system may be improved by performing autonomous optimization. For example, systems may be deployed that automatically adjust live infrastructure in real-time based on performance data—for example, increasing memory to handle a traffic spike. These actions are valuable, data-driven improvements that enhance performance and reduce costs.

A conflict can arise because of beneficial autonomous optimization, e.g., a decrease in memory allocation to an application, an increase in a number of central processor units (CPUs) allotted to an application, etc., may be detected as IaC drift. Standard IaC and infrastructure and application deployment tools (e.g., GitOps tools) are commonly designed to treat drift as an error. In most configurations, the default behavior of the infrastructure and application deployment tools is to detect and revert the change, automatically overwriting the optimization that may have been performed in order to force the computing environment back into alignment with the version control repository.

The existing landscape of infrastructure management tools is built on a paradigm of reversion and enforcement, which is fundamentally incompatible with preserving beneficial, autonomous changes. This leads to a scenario wherein either optimizations need to be disabled or have the optimizations be immediately undone by control systems.

Integrating autonomous optimization with a robust Infrastructure-as-Code (IaC) practice presents technical challenges. A first technical challenge is the proactive setting of operational guardrails, e.g., enabling customers to define and manage the operational guardrails for optimizations directly within their IaC workflow. A second technical challenge lies in reactive settings, e.g., enabling the system to reconcile the IaC drift that occurs when live optimizations cause the computing environment to differ from the specified source of truth. Techniques described herein can be utilized to provide a unified, closed-loop solution that addresses the aforementioned technical challenges.

In some implementations, direct modification of existing IaC files (e.g., Helm charts, templates, values files, etc.) may be performed via a request, e.g., a pull request or a merge request. The direct modification approach may prove to be challenging, in some scenarios.

Lack of Standardization: Customer IaC code can vary widely, making it difficult to create a reliable, one-size-fits-all solution for direct code modification.

Code Matching Complexity: Programmatically identifying and matching the exact code structures to inject changes may be complex and brittle.

Unreliable AI-Generated Diffs: Using large language models (LLMs) to generate the precise code differences (diffs) may be inconsistent.

Invasive Access Requirements: The direct modification approach requires providing the autonomous optimization system with broad, intrusive access to the entire codebase.

High Customer Effort: It would have forced customers to either grant invasive permissions or manually annotate their code, creating a significant adoption and maintenance barrier.

Techniques and/or methods described herein address both proactive control and reactive reconciliation of configuration settings from a live environment and configuration settings specified in a IaC code repository.

### Proactive Guardrails Suggestion via Transmitted Requests

A primary technical challenge is enabling users to define and control the boundaries for autonomous actions in an auditable manner. This problem is addressed via the following workflow:

Detect absence of policy: The system (e.g., an IaC synchronization system) is configured to manage optimization ranges (e.g., min/max CPU) from a dedicated file in the code repository of the user, such as Optimization_ranges.yaml. If this file, or an entry for a specific resource that is to be managed via autonomous resource optimization is missing, the ranges (guardrails) are generated.

Generate and Propose: Instead of simply failing or alerting, the system proactively generates a request (e.g., a pull request (PR) or a merge request) that includes ranges (e.g., allowable upper and lower bounds) for the computing resources that are to be managed (optimized) autonomously. The request may provide suggestions for the creation of a guardrail configuration file (e.g., optimization_ranges.yaml file) or may add a new entry to an existing guardrail configuration file that may be missing ranges for some resources. Completion of this stage leads to the inclusion of a guardrail configuration file in the version control repository that is complete with recommended default ranges for all managed computing resources.

Collaborate and Enforce: The request may be reviewed, adjusted as necessary, and merges with the version control repository to formally sanction the guardrails. This transforms the system from being a passive policy enforcer into an active collaborator that assists in authoring the governance rules themselves. Once merged, the autonomous engine is guaranteed to operate within these user-approved boundaries.

### Reactive “Detect-and-Sanction” Workflow

With the establishment of operable ranges for the settings of computing resources, the workflow can proceed to perform optimizations and determine optimal settings for one or more computing resources that lie within the operable (permitted) ranges.

For optimizations that cause drift, the system utilizes a detect-and-sanction paradigm that replaces an existing industry-standard “detect-and-revert” model.

Detect: An autonomous optimization is identified to a live resource, creating a beneficial difference between the live state (e.g., as detected in a live executing distributed computing system) and the version control (e.g., Git) repository.

Generate: The system programmatically generates a small, additive, and non-intrusive configuration file that declaratively represents the optimization. For example, a simple override file (e.g., for Terraform) or a patch file (e.g., a Kustomize path file for Helm) is generated.

Propose: The system automatically creates a request to add the newly generated configuration file to the repository. The request serves as the formal proposal to change the source of truth.

Sanction: The request may be automatically merged into the code repository (version control code repository). In some implementations, the automatic merging may be verified, e.g., by a script associated with the version control code repository. In some implementations, a human operator may review the request. The act of merging the request that includes an updated configuration file provides an explicit, auditable sanctioning of the optimization, providing a critical approval gate.

Apply: Subsequent to the merging of the updated configuration file, a standard Continuous Integration/Continuous Delivery (CI/CD) pipeline may be utilized to apply the updated IaC configuration. The live environment and the source of truth are now in sync at the new, optimized state.

This unified approach provides a complete solution, safely bridging the gap between dynamic, real-time operations and the stability of Infrastructure-as-Code. By using declarative overlays and override files, it is ensured that the version control code repository (e.g., a Git repository) remains the single source of truth while only requiring a simple, one-time setup from the customer. A request (e.g., a pull request (PR) or a merge request (MR)) is generated by the computer system(s) that performs the optimization, where the request includes a separate, additive configuration file containing the necessary changes. By reviewing and merging this automated request, the optimization may be sanctioned without any need for ongoing code customization, permanently aligning the codebase with the improved state of their infrastructure and closing the loop between automation and code. This approach enables easy integration with an existing CI/CD flow. Advantages of this approach includes:

Standard file generation: A standard file is generated and included with a request. Complex code and resource matching problems are avoided.

Easier onboarding: During a proof of value (POV) exercise, client(s) and/or prospective customer users can test the integration and examine the requests without integrating with the complete CI/CD flow.

Additional details are provided herein.

### Proactive Guardrails: IaC-Managed Optimization Ranges

In order to solve the technical challenge of defining boundaries and/or ranges for values of various resource attributes, optimization ranges are defined directly in the customer's version control code repository (e.g., Git repository). This approach makes the configurations similar to how replicas are managed in container orchestration systems (e.g., Kubernetes containers); a desired range is provided in code, and the autonomous system is utilized to dynamically determine the right value within those boundaries based on real-time conditions.

In some implementations, a user interface (UI) may be provided for a user to specify that the optimization ranges for their resources will be managed via their IaC repository. Users may define the ranges in a new, dedicated configuration file within their repository (e.g., optimization_ranges.yaml). The configuration file includes definitions for the acceptable minimum values and maximum values for specific resource attributes (e.g., CPU, memory, etc.).

In some implementations, suggestions for the acceptable minimum values and maximum values for specific resource attributes may be provided via a request, e.g., from an optimization engine, or a computer associated with a system that performs resource optimization. For example, if a flag for a configuration is enabled in a user interface, but a corresponding configuration file or a specific resource range (for a particular computing resource) is missing, a request may be initiated that includes the ranges for all resources, or to add a new entry to the existing configuration file with a recommended range for a particular resource, which may then be reviewed, adjusted, and merged.

Autonomous Adherence: Once the ranges are defined in a code repository, a code optimization engine utilizes (e.g., by a read of the configuration file) as its source of truth for guardrails. All subsequent autonomous actions are guaranteed to adhere to the customer-defined ranges, providing the client computing system with full control over the boundaries of optimization while still benefiting from dynamic adjustments within those boundaries.

### Reactive Reconciliation: Closing the Drift Loop

Containerized applications:

For containerized applications, the optimizations may be declaratively applied over existing configuration settings without any modification. For example, in distributed computing systems that utilize Helm Environments, a tool, e.g., Kustomize, may be utilized to declaratively apply optimizations over the top of existing Helm charts without modifying them directly.

### High-Level Example Workflow

Template Generation: The customer's CI/CD pipeline is adjusted to first use the helm template command. This command renders the Helm chart and its values.yaml into raw, final Kubernetes manifests. This output serves as the base configuration file.

Override File Generation: When a resource is optimized and an adjusted setting for one or more computing resources are determined, a human-readable patch file, e.g., a Kustomize patch file, is generated. This YAML file contains only the specific changes needed (e.g., the new memory limit for a specific container). A request that includes the patch file is programmatically transmitted to the repository of the customer computing system.

Merge and Apply: The request may be reviewed and merged and subsequently deployed. For example, the CI/CD pipeline may use the command kubectl apply-k. to deploy the application. The-k flag instructs kubectl to use its built-in Kustomize functionality. In this illustrative example, the Kustomize tool automatically reads a kustomization.yaml file, which directs it to first apply the base manifests from Helm and then apply the patch file over it.

Final State: The result is a final state in the computing cluster that includes both the customer's original chart configuration and the autonomous optimizations. The repository, e.g., the Git repository, remains the single source of truth for both layers.

This “Helm+Kustomize” pattern is a GitOps best practice. It cleanly separates the concerns of packaging (e.g., Helm) from environment-specific customization (e.g., Kustomize), thereby resolving IaC drift without forcing customers to fork or alter any existing Helm charts.

### Other Environments

Some computing systems, e.g., on-premises and cloud infrastructure components such as virtual machines and clusters may be managed (e.g., provisioned, updated and/or destroyed) based on human-readable configuration files that are authored by special tools, e.g., Terraform. For computer systems that are configured using Terraform, a two-part process may be utilized that combines a custom provider for discovery with a workflow for reconciliation.

Resource Mapping: A lightweight, custom provider, e.g., Terraform Provider for Optimization, is added to the customer's configuration. During a Terraform application (apply), the provider reads the Terraform state, creates a map of Terraform resource addresses (mapping data) to their corresponding cloud resource identifiers (IDs), and securely transmits this map to the optimization platform. The map provides the optimization platform with a key identifier that enables a linkage between a live resource and the specific line of code (e.g., in the IaC code repository) that defines it.

Automated Reconciliation: After a resource is optimized, mapping data is utilized to identify the exact Terraform address. A request is programmatically generated and transmitted to the customer's repository.

Override File Generation: The request introduces or modifies an override file (e.g., optimizations_override.tf). This file is utilized to redeclare the optimized resource with its new attribute values (e.g., an updated CPU value, memory value, etc.). Because of Terraform's file loading order, the values in the override file take precedence over the original configuration.

Merge and Apply: The request may be reviewed and merged, e.g., automatically. The next terraform apply will use the updated values from the override file, confirming that the code now matches the optimized reality.

This approach is non-intrusive, requiring only a small addition to the customer's Terraform configuration, and fully integrates into the existing workflow.

A technical problem in the software arts is the maintenance of synchronization of IaC settings with the infrastructure settings that are in use in the live environment. An additional technical problem is identification of the correct IaC setting in the code repository of the IaC file, for a particular infrastructure resource. For example, given a resource's attributes, the suitable section, variables, etc. in a file, have to be correctly identified. Subsequent to the identification, a request (e.g., a pull request (PR) or a merge request (MR)) is issued with the changes.

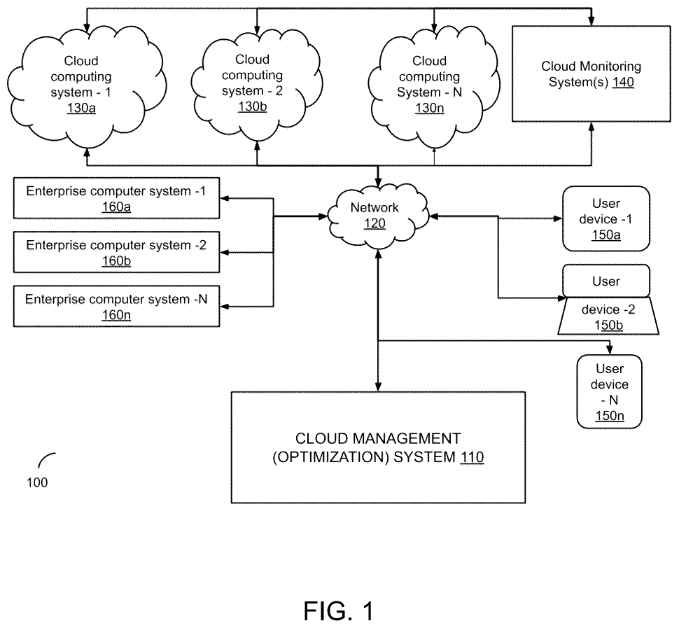

FIG. 1 is a diagram of an example distributed computing system environment, in accordance with some implementations. FIG. 1 illustrates an example system environment 100, in accordance with some implementations of the disclosure and illustrates a block diagram of an environment 100 wherein a cloud management service might be used. FIG. 1 and the other figures utilize similar (like) reference numerals to identify like elements. A letter after a reference numeral, such as “130,” indicates that the text refers specifically to the element having that particular reference numeral. A reference numeral in the text without a following letter, such as “130,” refers to any or all of the elements in the figures bearing that reference numeral (e.g., “130” in the text refers to reference numerals “130a,” “130b,” and/or “130n” in the figures).

The system environment 100 includes a cloud management system 110, which may include a variety of computer subsystems. Each of the subsystems can include a set of networked computers and devices.

The cloud management system is utilized to manage one or more distributed computing systems that are associated with one or more enterprise computer systems 160a, 160b, and 160n that utilize one or more cloud computing systems offered by respective infrastructure providers, 130a, 130b, and 130n that are connected via network 120.

Environment 100 may also include user devices 150a, 150b, and 150n that are utilized by users to access and/or execute one or more applications on the cloud computing systems. The cloud management system 110 itself may be implemented as a cloud-based system that is supplied and hosted by one or more third-party providers, and is accessible to users, e.g. system administrators and/or system reliability engineers (SREs), etc., via a variety of connected devices.

User devices 150 and enterprise computer system 160 may include any machine, system, or set of machines, systems that are used by an enterprise and users. For example, any of user devices 150 can include handheld computing devices, mobile devices, servers, cloud computing devices, laptop computers, workstations, and/or a network of computing devices. As illustrated in FIG. 1, user devices 150 might interact via a network 120 with a cloud computing system 130 that provides a service.

Cloud computing systems 130 (Distributed computing systems), cloud management system 110, and enterprise computer system 160 may utilize captive storage and/or cloud based storage. In some implementations, on-demand database services may be utilized. The data store may include information from one or more tenants stored into tables of a common database image to form a multi-tenant database system (MTS). A database image may include multiple database objects. A relational database management system (RDMS) or the equivalent may execute storage and retrieval of information against the database object(s).

Access to cloud management system 110, enterprise computer systems 160, cloud monitoring system 140, and cloud computing system 130 may be controlled by permissions (permission levels) assigned to respective users. For example, when an employee or contractor associated with a cloud management system 110 is interacting with enterprise computer system 160, cloud monitoring system 140, user device(s) of the employee or contractor is provided access on the basis of permissions associated with that employee or contractor.

Network 120 may be any network or combination of networks of computing devices that enable devices to communicate with one another. For example, network 120 can be any one or any combination of a LAN (local area network), WAN (wide area network), telephone network, wireless network, point-to-point network, star network, token ring network, hub network, or other appropriate configuration.

The computer systems may be connected using TCP/IP and use other common Internet protocols to communicate, such as HTTP, FTP, AFS, WAP, etc. Users may access the systems by utilizing different platforms and frameworks, e.g., by using single-page client applications that use HTML and TypeScript.

An application execution environment as described herein can be any software environment that supports execution of a software application. For example, an application execution environment supported herein may be an operating system (e.g., Linux, Windows, Unix, etc.), a hypervisor that supports execution of one or more virtual machines (e.g., Xen®, Oracle VM Server, Microsoft Hyper-V(™), VMWare® Workstation, VirtualBox®, etc.), a virtual computer defined by a specification, e.g., a Java Virtual Machine (JVM), an application execution container (e.g., containers based on Linux CGroups, Docker, Kubernetes, CoreOS, etc.), a process executing under an operating system (e.g., a UNIX process), etc. In some implementations, the application execution environment may be a software application, e.g., that is configured to execute on server hardware.

Techniques of this disclosure can be applied to a wide variety of deployment types, e.g., to distributed computing systems that utilize stateless containers, stateful containers, serverless deployments, etc.

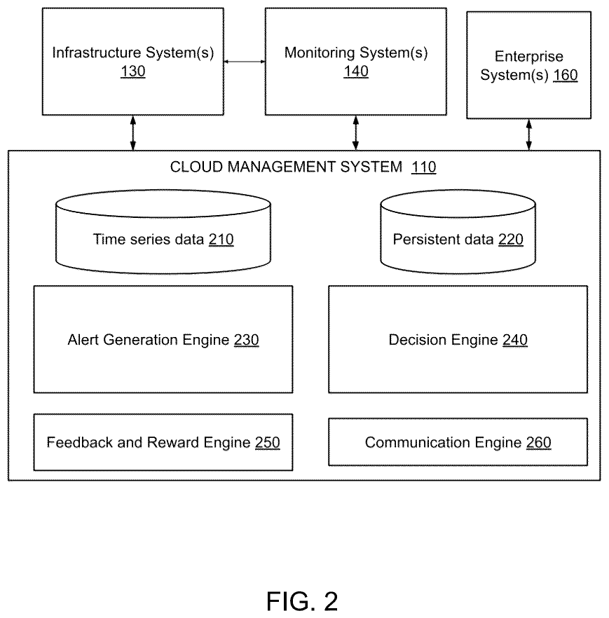

FIG. 2 illustrates a cloud management system, in accordance with some implementations. Cloud management system 110 may include subsystems configured for different functionality. In some implementations, cloud management system 110 may include an alert generation engine 230, a decision engine (core engine) 240, a feedback and reward engine 250, and a communication engine 260. Cloud management system 110 may also include one or more databases (data stores), for example, a time series database 210, and a persistent database 220.

In some implementations, databases 210 and 220 may be configured as external databases and/or cloud based data storage that is accessible to the cloud management system. In some implementations, the cloud management system 110 is communicatively coupled to one or more infrastructure systems 130, monitoring system(s) 140, and enterprise system(s) 160.

In some implementations, the cloud management system is configured to receive metric values associated with applications implemented on and/or executing on one or more infrastructure systems (cloud computing systems). The metric values may be received directly from the infrastructure systems and/or monitoring system(s) associated with respective infrastructure systems.

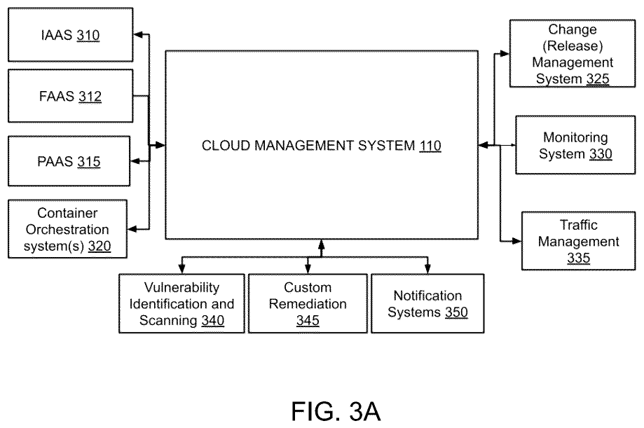

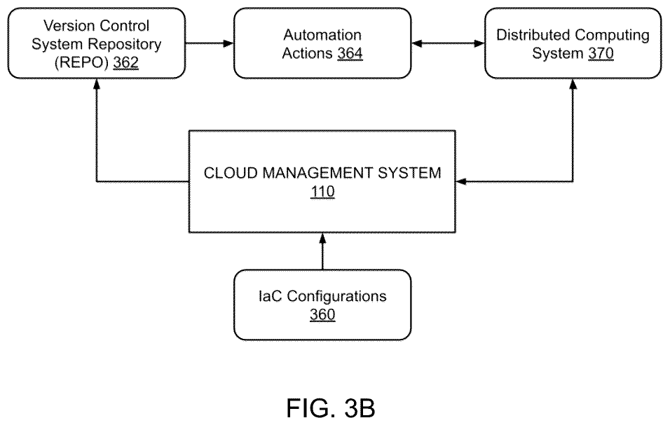

FIG. 3A is a diagram that depicts an example of a cloud management system and example interacting systems, in accordance with some implementations. As depicted in FIG. 3A, the cloud management system is configured to interact with multiple systems for various purposes. For example, the cloud management system may be coupled to Infrastructure as a service (IAAS) systems 310 that enable an enterprise to lease or rent servers for compute and storage resources. The cloud management system may be coupled to IAAS systems located in different geographical locations.

In some implementations, the cloud management system may be coupled to Function as a service (FAAS) systems 312, also referred to as serverless systems that enable an enterprise to execute one or more functions as a service, and where payment for the use of the infrastructure is made on a per-use-basis, based on units of time consumed and a cost that may be based on an allocation of computing resource.

FAAS systems enable enterprises to only pay for infrastructure at a time of use, and not during idle times. Additionally, the infrastructure sizing, etc. is implemented by the service provider, thereby freeing up the enterprise from costs and efforts associated with infrastructure management.

In some implementations, the cloud management system may be coupled to Platform as a service (PAAS) systems 315 that enable enterprises to lease servers as well as receive access to other development and deployment resources, e.g., middleware, development tools, database management systems, business analytics services, etc.; to Container Orchestration systems 320 that enable automation of containerized workloads, e.g., Kubernetes, Docker Swarm, Apache Mesos, etc.

In some implementations, the cloud management system may be coupled to one or more Change (release) Management System(s) 325 that enable enterprises to manage change and release processes, manage version control, implement CI/CD techniques, and/or to meet their auditing and compliance requirements; to one or more monitoring systems 330; and to Traffic Management System(s) 335 that are utilized to manage cloud traffic at various layers.

In some implementations, the cloud management system may be coupled to a vulnerability identification and scanning system 340, e.g., which may operate upon alerts received from the cloud management system to detect security issues/flaws and or attacks.

In some implementations, the cloud management system may be coupled to a Custom Remediation System 345, operable to perform custom remediations based on detected anomalies.

One or more notification systems 350, e.g., Slack, pager systems, email systems, etc. may be coupled to the cloud management system for the transmission of alerts, messages, and notifications to users.

FIG. 3B depicts an example architecture for the synchronization of configuration settings, in accordance with some implementations.

As depicted in FIG. 3B, cloud management system 110 is enabled to perform autonomous optimization of distributed computing system 370, e.g., detrimental optimal configuration settings for one or more computing resources associated with distributed computing system 370.

In some implementations, the IaC integration within the cloud management system 110 operates in a setting where IaC configurations are managed and version-controlled within a version control repository 362, e.g., a Git repository, with support for Git-hosting platforms such as Bitbucket, Github, GitLab, etc. The cloud management system 110 obtains IaC Configurations 360 (guardrail configuration settings) in order to ensure that optimization of attributes (settings) is performed within specified bounds, e.g., bounds specified by a client customer.

Based on optimization that is performed, updated configuration settings are merged into the version control repository 362 via a request transmitted from the cloud management system 110. Updated settings may then be deployed via automation action 364 by a CI/CD pipeline (not shown).

In some implementations, when a change to a configuration setting for a resource is initiated, a request (e.g., a pull request or a merge request) is triggered to the designated IaC repository. This request contains the updated configuration, and this workflow ensures any modifications made by the cloud management system undergo a review process within the version control system. The changes may be automatically reviewed and/or inspected before they are merged into the IaC repository, and an option may be provided to auto-merge requests based on adjusted settings received from the cloud management system (optimization system, optimization engine, etc.).

In some implementations, a recommend mode option may be provided by the cloud management system. In such implementations, recommendations for configuration changes are provided by the cloud management system, but the execution of these recommendations is offloaded to the IaC and its associated CI/CD pipeline. This approach ensures that the cloud management operates solely as an identifying and recommending tool without actually executing configuration changes.

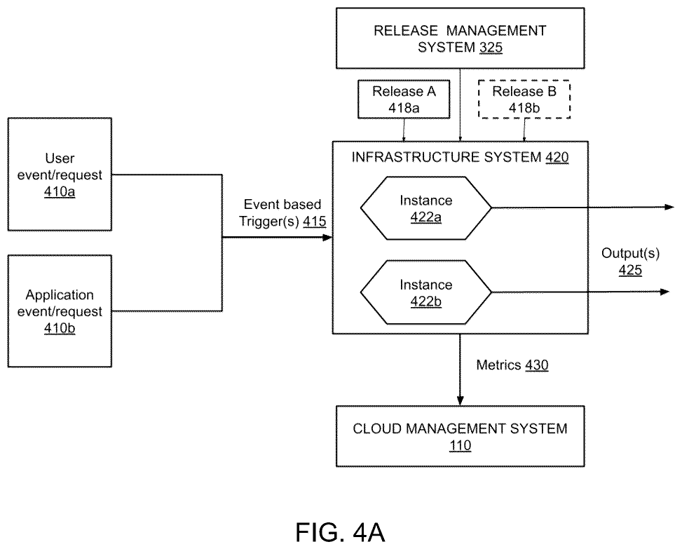

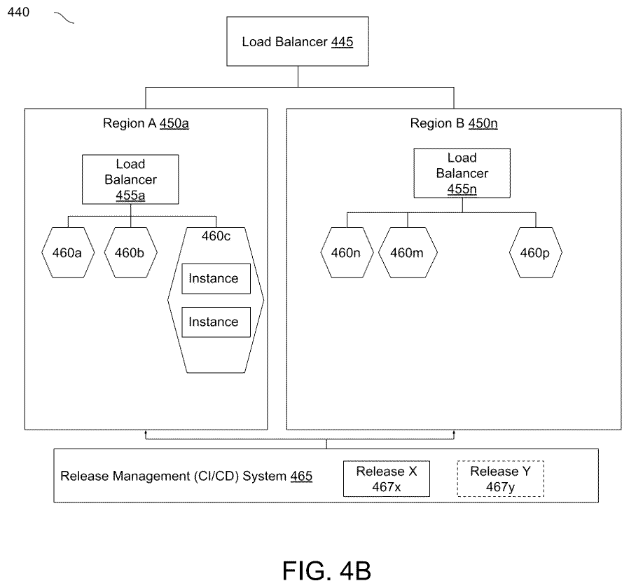

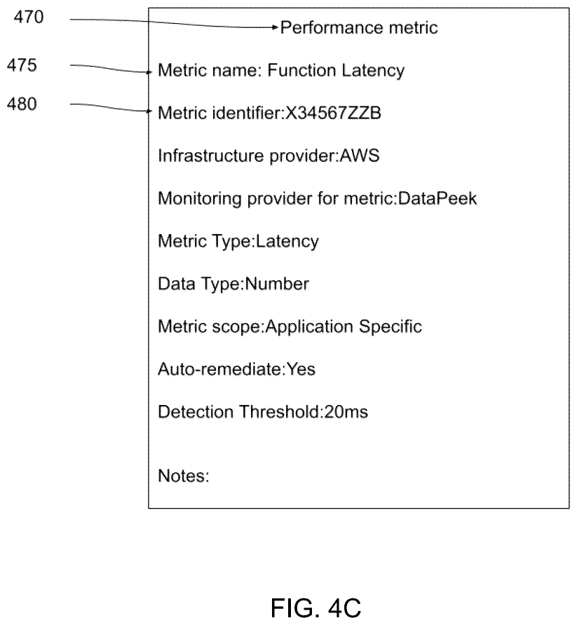

FIG. 4A depicts an example implementation of a serverless function in a distributed (cloud) computing environment, in accordance with some implementations.

A serverless function environment, sometimes referred to as a Function as a service (FAAS), enables a user to utilize infrastructure hosted by a third party provider. The execution of the function is based on a trigger/event trigger based on a user or application action. For example, as depicted in FIG. 4A, event based triggers 415 may originate from a user request or event 410a that may originate on a user device. For example, a user may initiate an upload of a picture from their mobile device, which may serve as an event trigger.

Event based triggers may also originate based on an application event/request 410b, which may be another software application that triggers an event request.

Based on the event trigger, an infrastructure system 410 may invoke an instance 422a or 422b and execute a function associated with the event trigger. The code for the function may be typically previously provided by the enterprise, e.g., as a container, code, function call, etc. For example, in the scenario described earlier, the function may be a codeset (code) that compresses the uploaded picture, and stores it in a database for subsequent access. New releases of the code for the function (software application) may be managed by a release management system, e.g., change management system 325 described with reference to FIG. 3.

For example, as depicted in FIG. 4A, a current release Release A 418a of a software application may be updated with a newer release Release B 418b, which is first tested in pre-production environments. Upon meeting the requirements for release of the software application, release management system 325 may update the software application with the new release. The release may be introduced at a predetermined time, e.g., a time of low traffic, which may be specified by a developer or system administrator.

The release may be implemented via a file transfer, e.g., of a code base, code image, or container image, or via an update to a location or link where a software application release is stored. In some implementations, a partial release may occur, where only a portion of live traffic is routed to the new release.

Each instance or execution of the function may generate one or more outputs, writes to one or more database(s), output to user devices etc.

Per techniques of this disclosure, one or more performance metrics 470 may be provided to the cloud management system 110, on a continuous, periodical, or indirect basis via a database or a monitoring system.

The metrics may include data that is aggregated as well as individual data points, and may include metrics such as arrival data for requests and/or queries that trigger the function(s), latency for each request, runtime, memory utilized, start-up time. In some implementations, the metrics may also include costs associated with the execution of the function.

FIG. 4B depicts an example topology within a distributed (cloud) computing environment, in accordance with some implementations. This example topology may be utilized as part of a cloud based implementation for one or more enterprise applications.

Distributed computing environments are commonly distributed over geographical regions to serve a diverse set of users, with dedicated computing resources earmarked for processing applications associated with a particular region. Within each region, one or more cloud computing systems may be utilized to serve and process applications. Load balancers at a global regional level are utilized to distribute the computing load evenly across available computing resources.

A first step undertaken by a cloud management platform is the discovery of a site (e.g., a client site) and charting of its topology. Subsequently, a complete and holistic state of all applications and infrastructure is registered, which enables complete observability and permits the system to become self-aware. Application tags for each application may be utilized to infer a particular site's infrastructure as well as to create custom profiles.

In this illustrative example, an example topology 440 of the computing environment is depicted in FIG. 4B. A load balancer 445 at the global level is utilized to receive requests, e.g., http requests, etc., from users and distribute it to regional computing clusters 450a or 450n.

Within each region, a load balancer may be utilized to distribute computing tasks to available resources. For example, load balancer 455a may be utilized in region 450a, and load balancer 455n may be utilized in region B.

Based on the type of requests, the load balancers may distribute tasks to available virtual machines within the cluster. Specialized management tools and software may be available for the distribution of tasks to resources.

In some implementations, a virtual machine may be utilized for only one type of application, whereas in other implementations, a virtual machine may be utilized for multiple types of applications, and even multiple applications from multiple client users.

Specific infrastructure providers may utilize different techniques and tools to track assignment of computing tasks to resources. For example, in some implementations, a load balancer may maintain a list of currently executing tasks, and alternately, a history or log of tasks processed as well.

In some other implementations, e.g., containerized systems, a state of a cluster of compute resources may be represented as objects that describe what containerized applications are running on which nodes, resources allocated to those applications, and any associated policies.

In some implementations, computing resources may be configurable. For example, in an environment that utilizes virtual machines, a quantity of memory or CPU allotted to each virtual machine may be configurable. Configurable environments may provide advantages by adjusting the resources based on the type of loads being handled. Configuration settings may be stored and/or adjusted autonomously or via human intervention.

A release management system 465 may be utilized as part of a CI/CD system to provide a suitable code base, image, etc., for utilization. The release management system may be integrated with the cloud management system.

For example, an existing release of software application, Release X 467x may have an updated release, Release Y 467y, which may be introduced to the production environment 440 by release management system 465. The release may be performed in a calibrated manner with suitable integration with one or more load balancers. In some implementations, a new release may be introduced to only selected regions of a plurality of regions, e.g., only Region B. In some other implementations, a new release may be introduced to a selected number or percentage of computing devices utilized by the software application. This may be achieved via suitable instructions provided to one or more load balancers that are utilized to handle live traffic.

FIG. 4C depicts an example performance metric record utilized in monitoring a distributed computing system, in accordance with some implementations

As described earlier, the cloud management system may receive and/or obtain one or more metric values from a cloud computing system and/or monitoring system associated with one or more applications that are being monitored and managed.

In some implementations, the metric values may be automatically received by the cloud management system. In some other implementations, the metric values may be obtained by querying a database, e.g. Prometheus, etc. at periodic intervals.

In this illustrative example, an example monitoring metric record for a performance metric 470 is depicted, with associated attributes; a metric name 475, a metric identifier 480, and other attributes, e.g., an originating infrastructure provider (cloud computing provider) identifier, a monitoring metric provider, a metric type, a data type associated with the monitoring metric, metric scope, an auto remediate field that indicates whether auto remediation should be performed based on the particular metric, a detection threshold for any anomaly detection, and notes associated with a metric.

The list of attributes for the example metric provided above is provided as an example, and is not exhaustive, and specific implementations may utilize additional metric values for each application being managed/monitored, and some implementations may omit some of the attributes altogether.

Metric values and their attributes may be specified by a user, e.g., a user or administrator associated with an enterprise system, monitoring system, or cloud computing system provider, or be automatically inferred by the cloud management system.

A suitable user interface may be utilized to enable users to define/specify metric values and associated attributes. Menu options, e.g. pull-down menu options, etc., may be provided to enable easy user selection of monitoring metric and associated attributes For example, a metric type attribute for a monitoring metric may be specified to be one of a volume, saturation, latency, error, ticket; a data type for a monitoring metric may be specified to be one of a number, a percentage, or a counter; a metric scope for a monitoring metric may be specified to be one of site wide, application specific, load balancer, or instance.

In some implementations, the attributes may be specified by tags that are associated with the monitoring metric and provided by the cloud computing system or the monitoring system that is generating and providing the metrics.

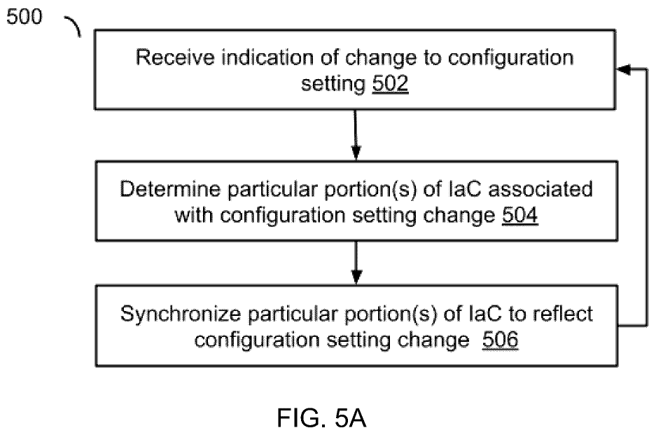

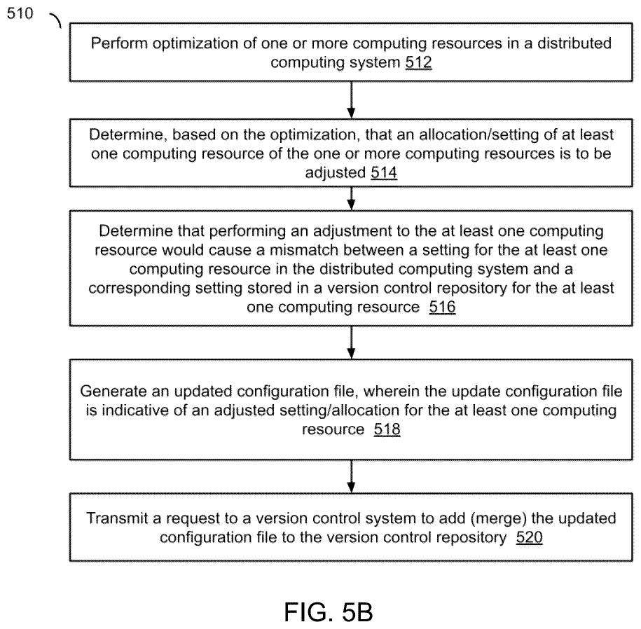

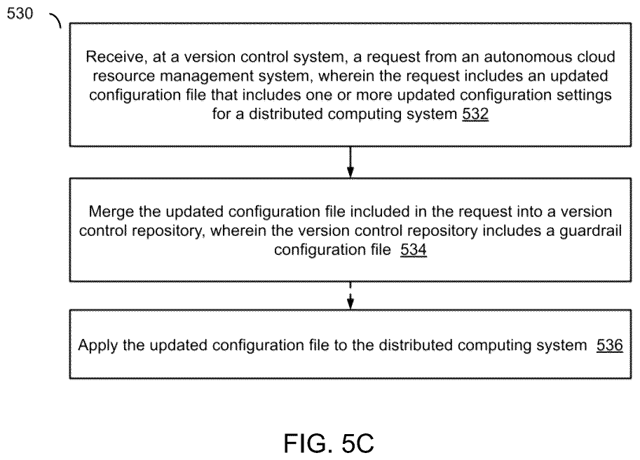

FIG. 5A is a flowchart illustrating an example method to synchronize configuration settings in an IaC environment, in accordance with some implementations.

The distributed computing system may be a serverless computing system or a virtualized environment, and the software application may be a function or package configured to be executable on the serverless computing system or in the virtualized environment. For example, the distributed computing system may be a containerized computing system, a Kubernetes cluster, a stateless application, a Platform as a service (PAAS), etc.

In some implementations, method 500 (and other methods described herein) can be implemented, for example, on cloud management system 110 described with reference to FIG. 1. In some implementations, some or all of the method 500 can be implemented on one or more enterprise computer systems 160, on cloud computing system 130, on cloud monitoring system 140, as shown in FIG. 1, on and/or on a combination of the systems. In the described examples, the implementing system includes one or more digital processors or processing circuitry (“processors”), and one or more storage devices (e.g., databases 210, 220, or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can transmit (provide) results or data to the first device.

In some implementations, the method 500, or portions of the method, can be initiated automatically by a system. In some implementations, the implementing system is a first device. For example, the method (or portions thereof) can be periodically performed, or performed based on one or more particular events or conditions, e.g., receiving a notification of an updated configuration setting for a software application, receiving a notification of a new release of a software application, reception of performance metric data, at a predetermined time, a predetermined time period having expired since the last performance of method 500, and/or one or more other conditions or events occurring which can be specified in settings read by the method.

At block 502, an indication of a change to a configuration setting is received. Block 502 may be followed by block 504.

At block 504, a particular portion(s) of the IaC repository associated with the configuration setting change is determined. Block 504 may be followed by block 506.

At block 506, the particular portion(s) of IaC are adjusted (synchronized) to reflect the configuration setting change.

Blocks 502-506 can be performed (or repeated) in a different order than described above and/or one or more steps can be omitted.

FIG. 5B is a flowchart that illustrates an example method to synchronize configuration settings (optimal resource allocation setpoints), in accordance with some implementations.

In some implementations, the method 510, or portions of the method, can be initiated automatically by a system. In some implementations, the implementing system is a first device. For example, the method (or portions thereof) can be periodically performed, or performed based on one or more particular events or conditions, e.g., receiving a notification of an updated configuration setting for a software application and/or computing resource, receiving a notification of a new release of a software application, reception of performance metric data, at a predetermined time, a predetermined time period having expired since the last performance of method 510, and/or one or more other conditions or events occurring which can be specified in settings read by the method.

Method 510 may begin at block 512.

At block 512, an optimization of one or more computing resources in a distributed computing system is performed. In some implementations, the optimization of the one or more computing resources may include determining configuration settings for one or more computing resource(s) in a live environment.

In some implementations, the optimization may be performed based on an analysis of performance metrics, load, etc.

The first metric data may include one or more metrics, e.g., performance metrics that are being monitored for the software application. For example, the first metric data may include a latency of execution, CPU power consumed, end to end user latency, etc. for the software application.

In some implementations, the first metric data may be specified by a user. In some implementations, credentials for a particular infrastructure provider and/or monitoring provider are obtained, and the metric data (e.g., a plurality of metrics) may include all metrics that are generated for the set of applications associated with a client. In some implementations, a list of available monitoring metrics as well as a set of key metrics may be obtained, e.g., from an enterprise client.

In some implementations, configuration information, credentials, etc., are stored in a persistent database, e.g., data store 220 described with reference to FIG. 2. In some implementations, a list of monitoring metrics may be obtained from cloud providers, whereas, in some other implementations, a list of monitoring metrics may be obtained from monitoring providers. In some implementations, the monitoring metrics may be obtained from a combination of cloud providers and monitoring providers. In some implementations, a list of monitoring metrics may be a human curated list of monitoring metrics.

The monitoring metrics may include error data, entries within log files, and any other information associated with parameters and metrics that are indicative of system performance and health as well as application performance and health.

The monitoring metrics can include metrics from multiple applications, and from multiple parts of an integrated software chain. Different components in the application stack may provide their own monitoring metrics. For example, application level metrics may be obtained that are associated with a particular application; monitoring metrics may be obtained from one or more load balancers that manage computing resources and may include metrics such as a number of connections, and metadata associated with each connection; an infrastructure provider, e.g., AWS, may provide monitoring metrics such as instance identifier(s), CPU usage per minute for each instance, and input/output (I/O) bytes associated with each instance, etc.

Example metrics may include CPU utilization, latency, memory utilization, Disk I/O for an application at an application and/or an instance level. Some monitoring metrics may be user experience based metrics, that may be obtained or inferred based on actual user experience with an application.

The monitoring metrics may be received from different cloud providers and/or monitoring providers. In some implementations, received monitoring metrics may be normalized to a single format (standard), which may be applied across all providers to enable comparison and combination of monitoring metrics received from different sources.

In some implementations, the monitoring metrics are received as time-series data associated with a particular time period (interval). In some implementations, additional normalization operations may be performed such that the time-series data of different monitoring metrics are synchronous and refer to the same time period.

In some implementations, the time-series data is obtained by querying a database where the time-series data is stored, e.g., an external data source at a cloud computing system or a cloud monitoring provider or third party provider. In some implementations, the time-series data may be obtained by querying a time-series database, e.g., database 210 described with reference to FIG. 2. In some implementations, the time-series data may be obtained from a monitoring solution and time series database, e.g., Victoria Metrics, Prometheus, etc. In some implementations, the time-series data may be obtained via a pull model wherein an initial request for data may originate from the cloud management system, which is then responded to by the database server.

The time series data may be obtained for multiple time intervals, e.g., time intervals of 2 days, 7 days, 3 months, 6 months, etc. In some implementations, different time intervals may be utilized for different applications and/or infrastructure providers.

In some implementations, normalization of the obtained monitoring metrics may be performed, e.g., if received from different sources that have different scales, units, etc. In some implementations, a topology of the distributed computing system may be inferred periodically, e.g., every 20 minutes, every 30 minutes, etc.

In some implementations, the metric data may be received that corresponds to a period of time that has already transpired, and is received with a delay. In some implementations, the metric data may be received in real-time, or near real-time.

In some implementations, the software application may be a serverless function. In a serverless computing environment, an execution model is provided for a distributed (cloud) computing system in which a cloud provider dynamically allocates, and then charges an enterprise user for the compute resources and storage needed to execute a function, application or code provided by the enterprise user. Serverless functions are event-driven, meaning the code provided by the enterprise user is invoked only when triggered by a request originating from a user and/or application.

In some implementations, the software application may be an application implemented over a set of virtual machines, e.g., similar to a system depicted in FIG. 4B. In a virtual computer system, computers are virtualized, e.g., software-based or virtual versions of a computer are created, each with dedicated amounts of CPU, memory and storage that are provided from a physical host computer. Configuration settings may be utilized to specify the amount of CPU, memory, and storage to be provided. In managing a virtual computing system, metric data may include data from multiple instances of the application that have previously executed on different virtual machines of the distributed computing system.

In some implementations, historical metric data associated with the software application may be obtained. The obtained historical metric data may be programmatically analyzed along with the first metric data to determine an allocation of a computing resource.

In some implementations, the distributed computing system is configured using a container orchestration platform that is utilized to automate the deployment, management, and scaling of containerized applications, handling tasks like load balancing, self-healing, service discovery, and network configuration across clusters of servers.

In some implementations, the distributed computing system is configured using a cloud infrastructure provisioning system. For example, the cloud infrastructure provisioning system may be utilized for multi-tier applications that scale up or down frequently to meet loads and/or demands. Preconfigured templates may be utilized to set up coding environments and to deploy infrastructure like firewalls and routers in the cloud.

In some scenarios (implementations), it may be determined that there is no defined range of values for the one or more computing resources included within the version control repository. In such a scenario, a user interface may be provided to enable a user to generate the range of values for the one or more computing resources for inclusion in a guardrail configuration file.

For example, a user interface (UI) may be provided to enable a user to specify that optimization ranges for resources are to be managed via an IaC repository and to enable the user to define optimization ranges in a dedicated configuration file within the IaC repository, the configuration file defining acceptable minimum and maximum values for specific resource attributes.

In some other implementations, when it is determined that there is no defined range of values for the one or more computing resources included within the version control repository, a range of values for the one or more computing resources may be first calculated, (e.g., by an optimization engine) and the range of values may be transmitted to the version control system for inclusion in a guardrail configuration file within the version control repository.

Block 512 may be followed by block 514.

At block 514, it may be determined, based on the optimization, that a setting (e.g., resource allocation setting) of at least one computing resource of the one or more computing resources is to be adjusted.

In some implementations, prior to performing the optimization, (or determining the adjustment), an optimization engine may verify that the adjusted setting for the at least one computing resource lies within a corresponding range of values for the at least one computing resource included in a guardrail configuration file.

Block 514 may be followed by block 516.

At block 516, it is determined that performing an adjustment to the at least one computing resource would cause a mismatch between a setting for the at least one computing resource in the distributed computing system and a corresponding setting stored in a version control repository for the at least one computing resource. For example, it may be determined that performing an adjustment to the live environment based on the adjusted setting would cause a drift in the IaC state. Block 516 may be followed by block 518.

At block 518, an updated configuration file is generated, wherein the updated configuration file is indicative of an adjusted setting (e.g., adjusted resource allocation setting) for at least one computing resource. In some implementations, the updated configuration file is an additive, non-intrusive configuration file that declaratively represents the optimization.

In some implementations, the updates configuration file includes a declarative overlay that is an application layer statement that defines the desired state or structure of a computing element, rather than specifying the step-by-step instructions for how to create or modify it. Mechanisms associated with the distributed computing system then automatically implement and maintain the specified state. In some implementations, the declarative overlay enables definition of a desired topology and properties of a distributed computing system, abstracting away complex, low-level details of implementation.

In some implementations, the updated configuration file provides instructions that includes an identification of particular lines of code in a configuration file(s), and instructions of one or more of: addition of lines of code to the configuration file(s), replacement of lines of code of the configuration file(s), and combinations thereof.

In some implementations, the configuration file may be a single file, while in other implementations, the configuration file may actually be multiple individual files. Block 518 may be followed by block 520.

At block 520, a request, e.g., a merge request, a pull request, etc., may be transmitted to a version control system to add the updated configuration file to the version control repository.

In some implementations, prior to transmission of the request, the request is generated. In some implementations, a confirmation of receipt of the request may be transmitted by the version control system and received at the optimization system.

In some implementations, the adjusted settings may be applied to the live environment as soon as the request is transmitted, whereas in some other implementations, the adjusted settings are applied upon receipt of a confirmation of the merging of the updated configuration file.

In some implementations, the optimization process may be performed such that settings from the guardrail configuration file are taken into account. In some other implementations, the optimization process may be performed without knowledge of the settings from the guardrail configuration file.

In some implementations where the distributed computing system is configured using a container orchestration system, the updated configuration file is a patch file, e.g., a Kustomize patch file that includes one or more environment specific transformers and generators that can be utilized to modify resources associated with each environment in the distributed computing system. The patch file enables customization without altering the original base manifests, enabling environment-specific configurations or minor adjustments.

In some implementations where the distributed computing system is configured using a cloud infrastructure provisioning system, the updated configuration file is operable to modify an override file that can be utilized to redeclare the at least one computing resource with its adjusted setting.

In some implementations, subsequent to updating the configuration file, e.g., by merging the updated configuration file into the version control repository, a CI/CD system may deploy the updated configuration. In some implementations, the CI/CD deployment may be based on a particular frequency of deployment. In some implementations, the CI/CD deployment may be triggered by changes to the code repository, e.g., a change introduced by the merging of a request that includes updated configuration settings.

In some implementations, method 510 may further include applying updated configuration settings to the distributed computing system. In some implementations, applying the updated configuration settings includes reading the settings, converting the settings to specific topology of the system; comparing the topology to a live system, and making any adjustments necessary.

Blocks 512-520 can be performed (or repeated) in a different order than described above and/or one or more steps can be omitted.

FIG. 5C is a flowchart that illustrates another example method to synchronize configuration settings (optimal resource allocation setpoints), in accordance with some implementations.

Method 530 may begin at block 532.

At block 532, a request is received at a version control system from an autonomous cloud resource management system. In some implementations, the request may be a pull request or a merge request that includes an updated configuration file that includes one or more updated configuration settings for a distributed computing system. Block 532 may be followed by block 534.

At block 534, the updated configuration file included in the request is merged into a version control repository. In some implementations, the version control repository includes a guardrail configuration file, and the updated configuration file included in the request includes a setting for a resource attribute associated with one at least one computing resource that lies within specified values included in the guardrail configuration file. Block 534 may be followed by block 536.

In some implementations, method 530 may further include generating the guardrail configuration file that includes a range of acceptable values for resource attributes associated with one or more computing resources of a distributed computing system.

In some implementations, generating the guardrail configuration file may include generating the guardrail configuration file based on suggested values received from an autonomous cloud resource management system.

At block 536, the updated configuration file may be applied to the distributed computing system. In some implementations, the updated configuration file is operable to modify an override file that can be utilized to redeclare the at least one computing resource with an adjusted setting included in the one or more updated configuration settings.

In some implementations, the updated configuration file is a patch file, (e.g., a Kustomize patch file) that includes one or more environment specific transformers and generators that can be utilized to modify resources associated with each environment in the distributed computing system.

In some implementations, synchronization of configuration settings may be performed by a system for integrating autonomous computing resource optimization with Infrastructure-as-Code (IaC) workflows. In some implementations, the system may include an optimization engine configured to autonomously optimize computing resources in a live environment and to determine updated configuration settings for the live environment and a reconciliation module.

In some implementations, the reconciliation module may be configured to detect a mismatch between a live environment configuration and a configuration defined in a version control repository resulting from the autonomous optimization, and generate a pull request to the version control repository, the pull request including an additive configuration file that reflects the updated configuration settings.

In some implementations, the live environment is a cluster of containers, and the additive configuration file is a configuration patch file., e.g., for Helm environments.

In some implementations, the system may further include a custom provider, e.g., a Terraform provider or plugin that is configured to map resource addresses to corresponding cloud resource identifiers (IDs) and securely transmit the map to the system.

In some implementations, the reconciliation module is configured to generate the pull request with an override file that redeclares the optimized resource with new attribute values.

Blocks 532-536 can be performed (or repeated) in a different order than described above and/or one or more steps can be omitted.

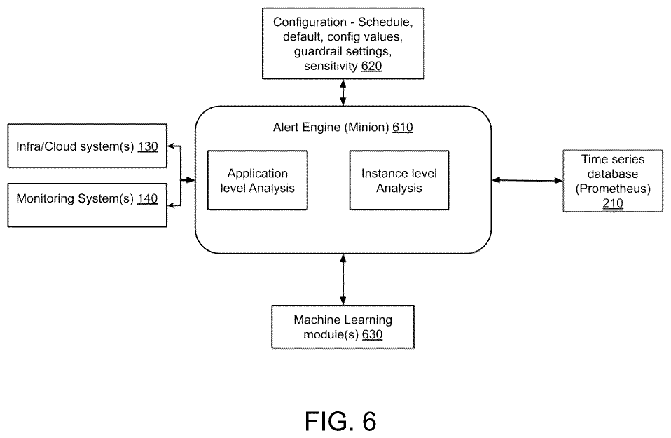

FIG. 6 is a block diagram that depicts an example implementation of an alert engine (minion) and interacting components, in accordance with some implementations.

As depicted in FIG. 6, alert engine 610 is configured to receive inputs, e.g., metrics from infrastructure/cloud systems 130 and/or monitoring systems 140. The alert engine is also coupled to configuration module 620, which may store information about one or more applications to be monitored, metrics to be monitored, metadata associated with the metrics, client organization preferences and priorities, thresholds, sensitivity coefficients associated with various metrics and applications, etc.

The alert engine (minion) is coupled to time series databases 210, e.g., a Prometheus database, that may be utilized to obtain time-series data about various metrics associated with one or more applications. In some implementations, time-series data may be obtained with a predetermined delay, e.g., a 20 minutes delay. In some implementations, the time-series data may be obtained with a dynamic lag (delay), and the delay may be specified during the data transfer or may be subsequently estimated based on time-stamp data, etc. In some implementations, an adjustment is made to extrapolate the lagged (delayed) time-series data in order to estimate a current value of time-series data based on previously received time-series data, and release analysis may be performed on extrapolated data determined in this manner.

For example, an estimated current value based on just received (which may be delayed by a predetermined time, or may include delay that can be estimated based on timestamps) and patterns of time-series determined based on a history of received time-series data, e.g., last 2 sets, last set, etc. In some, adjustments may be made to also include seasonality based trends.

The alert engine 610 is also coupled to one or more machine learning module(s) 630 that are utilized for anomaly and outlier detection. The alert engine may be utilized to perform checks on various types of anomalies, and may utilize multiple techniques for anomaly detection.

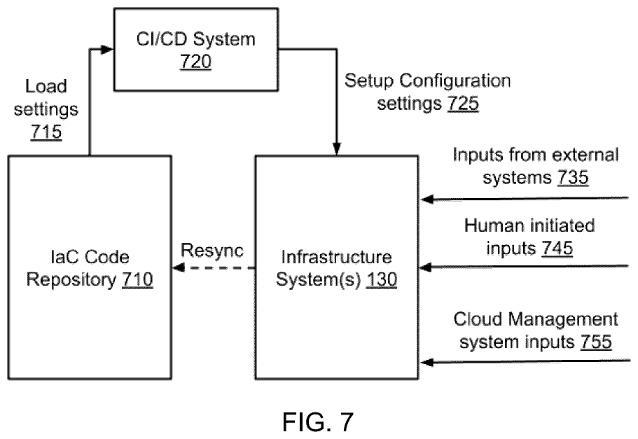

FIG. 7 is a block diagram illustrating IaC synchronization, in accordance with some implementations.

Different modes may be utilized for mapping resources to IaC configuration files, thereby providing flexibility and adaptability to diverse infrastructure management needs:

Cloud Management System Managed Mode: In this mode, the cloud management system takes complete control of configuration file management. A new file is created for each resource and a standardized configuration file generated that includes all necessary details. For example, in Terraform environments, this may entail creating a Terraform values file.

Tag-Managed Mode: In this mode, resources are tagged with metadata indicating the full path of their corresponding IaC configuration file, along with the update variable name. The cloud management system utilizes these tags to effectively manage configurations.

IaC-Managed Mode: In this mode, mapping between resources and IaC files, as well as the corresponding variables within those files is automatically identified. By analyzing the infrastructure and its associated IaC configurations, the cloud management system streamlines the mapping process for enhanced management efficiency. In some implementations, machine learning (ML) techniques may be utilized to determine the mappings.

In each of these modes, a confidence threshold is utilized to determine the accuracy of mappings. Low-confidence mappings are presented for verification to ensure transparency and allow you to confirm or adjust mappings as needed. This verification step enhances the reliability and accuracy of configuration management within the cloud management system and is used to enhance the ability to autonomously map other resources to IaC files.

### Terraform Templates and YAML Value Files

Terraform Templates Terraform templates provide a way to reuse and customize Terraform code. They're essentially a mechanism for creating reusable modules that can be incorporated into different infrastructure projects. Templates can encapsulate common patterns, configurations, or components, making it easier to manage and maintain complex infrastructure.

YAML Value Files YAML (YAML Ain′t Markup Language) is a human-readable data-serialization language commonly utilized to author configuration files. In the context of Terraform, YAML value files are used to store and manage configuration values that can be dynamically injected into Terraform templates. This separation of infrastructure definition from configuration data promotes modularity, reusability, and easier management.

Benefits of Using YAML Value Files:
Separation of Concerns: Clearly separates infrastructure definition from configuration values, improving code organization and readability.
Flexibility: Allows for easy modification of configuration values without altering the underlying template code.
Reusability: Can be used with multiple Terraform templates, reducing code duplication and simplifying management.
Version Control: YAML files can be version-controlled, making it easier to track changes and manage different configurations.

### Example of a Terraform Template and YAML Value File

template.tf:
Terraform
module “example_resource” {
source= “./modules/example_resource”
variable “resource_name” {
type=string
default= “my_resource”
}
variable “resource_type” {
type=string
default= “aws_instance”
}
}
values.yaml:
YAML
resource_name: “my_custom_resource”
resource_type: “aws_s3_bucket”
To use the template with the YAML value file:
Terraform
terraform {
required_providers {
aws={
source= “hashicorp/aws”
version= “˜>4.0”
}
}
}
module “example_resource” {
source= “/template.tf”
variables={
resource_name=var.resource_name
resource_type=var.resource_type
}

In this example, the template.tf file defines a reusable module with variables. The values.yaml file provides specific values for those variables. When the Terraform configuration is executed, the values from the YAML file are used to populate the module, creating the desired infrastructure resources. By using Terraform templates and YAML value files, modular, reusable, and manageable infrastructure code can be created, making it easier to manage complex cloud environments.

### Cloud Management System Managed Mode

Existing Templates and Value Files: The customer already has a set of Terraform templates and corresponding YAML value files defining their infrastructure.
Pull Requests: The cloud management system generates pull requests containing new YAML files in its standard format, reflecting the changes the cloud management system intends to make to the infrastructure.
No Existing File Modification: A customer's existing templates or value files are not directly modified.
Integration Required: The customer will need to integrate the new YAML files generated by the cloud management system into their existing templates to apply the desired changes.
1. Separation of Concerns: A clear separation is maintained between generated configuration files and the customer's existing templates and value files. This enables better control and flexibility.
2. Pull Request Workflow: The use of pull requests ensures a transparent and collaborative process for reviewing and approving proposed changes.
3. Manual Integration: While the necessary configuration files are provided, the customer still needs to integrate them into their existing templates. This might involve modifying existing variables or creating new ones to accommodate the changes.

### Tag-Managed Mode

Tag-Managed Mode is another configuration management approach within the cloud management system platform. Tag-Managed Mode relies on user-defined tags to link resources to their corresponding IaC configuration files. Tags are added to identify files and sections for each change.

Key Characteristics of Tag-Managed Mode:
Resource Tagging: Users must tag each resource with metadata that specifies the full path of its IaC configuration file and the update variable name within that file.
Pull Requests: When the cloud management system detects changes to the resource, it generates a pull request to the IaC repository, proposing updates to the specified configuration file.
Customer-Driven Updates: The customer is responsible for applying the changes from any pull request to their existing templates or value files.

Benefits of Tag-Managed Mode:
Greater Flexibility: Tag-Managed Mode offers more flexibility than cloud management system-Managed Mode, as it allows customers to maintain control over their configuration files and their structure.
Leverages Existing IaC Practices: By utilizing existing tagging mechanisms, Tag-Managed Mode can integrate seamlessly with existing IaC workflows.
Reduced Reliance on cloud management system: Customers have more control over their infrastructure configuration, reducing their reliance on cloud management system's automated processes.

### IaC-Managed Mode

IaC-Managed Mode is the most automated of the three configuration management modes offered by the cloud management system. In this mode, the cloud management system takes the initiative to identify and map resources to their corresponding IaC configuration files, as well as the relevant variables within those files. This mode assumes standardization in the IaC code. In some implementations, sample resources are considered to find potential matching files and variables. Each of the matches are scored. High confidence matches may be utilized as is, while user feedback is obtained when no high confidence matches are found. Once sample matches are established, matches are rerun on all resources.

Key Characteristics of IaC-Managed Mode:
Automated Mapping: cloud management system uses AI techniques to analyze the infrastructure and its associated IaC configurations, automatically identifying the relationships between resources and their corresponding variables.
Minimal User Intervention: Unlike the other modes, IaC-Managed Mode requires no manual tagging or integration from the customer.
User Feedback: While the cloud management system aims to automate the mapping process, it might require user feedback to validate mappings or correct errors.

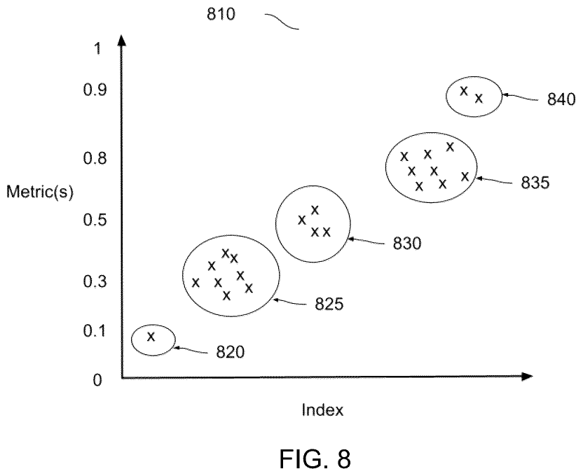

FIG. 8 depicts example detection of outliers, in accordance with some implementations.

Outlier detection may be utilized to identify instances of new releases of applications that are associated with abnormal behavior that may be indicative of one or more problems or anomalous behavior. For example, if in a certain scenario, ten instances are associated with an application, it is expected that they are substantially similar in behavior and are expected to have the same range of values for metrics such as CPU, memory, latency, etc. Anomaly detection (outlier detection) is utilized to determine if one or more instances associated with a software application are behaving differently from their peer instances, and additionally determining what proportion of the instances of the software application behaving differently are associated with a new release of the software application. In some implementations, outlier detection is performed one metric at a time, for all monitored metrics across a set of monitored applications.

For a particular metric of an application, the corresponding metric value is obtained for all instances of the application, including from pre-release and post-release versions. The metric values may be obtained, for example, by querying a suitable time-series database, as described earlier.

A recursive clustering process may be utilized to determine an optimal number of clusters. Clusters with a varying number of clusters are generated based on the metric values. A silhouette coefficient (score or value) is determined for the clusters that is indicative of a tightness of the cluster. The silhouette coefficient for a set of clusters of a metric is a measure of how similar a metric value of an instance in the cluster is to metric values of other instances in the cluster compared to metric values of instances in other clusters. The silhouette coefficient can range from −1 to +1, wherein a high value for an instance indicates that the instance is well matched to other instances in its own cluster and poorly matched to instances in neighboring clusters. If most instances have a high value, then the clustering configuration is deemed suitable. If many instances have a low or negative value for a silhouette coefficient, then the clustering configuration may have too many or too few clusters.

In some implementations, a configuration with a number of clusters that yields the highest silhouette coefficient for instances is selected as an optimal configuration of clusters. In some implementations, the first configuration that meets a predetermined threshold of silhouette coefficient may be selected. An analysis of the clusters thus formed is undertaken. In some implementations, historical values of the metric may be utilized to validate the instance values.

FIG. 8 depicts an illustrative example configuration of instances that have been clustered into 5 clusters based on their metric values.

As can be seen, there are two large clusters, cluster 825 and cluster 835 of instances, and relatively smaller clusters, cluster 820, cluster 830, and cluster 840.

Per techniques of this disclosure, clusters with a large number of instances are deemed normal. In some implementations, clusters with a number of instances that meet a deemed predetermined threshold (measured as a percentage/ratio of total number of instances) are deemed to be clusters with normally operating instances. In this illustrative example, cluster 825 and cluster 835 are considered to be clusters with normally operating instances. Normally operating instances are excluded from consideration as outlier instances.

Clusters of instances where the instance values (average value of instances in cluster, centroid value for cluster, etc.) lie between normally operating instances are considered to be migratory clusters, e.g., clusters of instances that are in the process of changing a state (of metric value) from one cluster to another. In this illustrative example, cluster 830 includes instances with metric values that lie between the metric values of instances in cluster 825 and cluster 835 and is therefore considered to be a migratory cluster. Instances that are located in migratory clusters are excluded from consideration as outlier instances.

Clusters that have a relatively small number of instances, e.g., clusters with a number below a predetermined threshold ratio (or percentage of total instances), and that are not migratory clusters are considered ‘lonely’ clusters are considered as candidate outlier clusters. In this illustrative example, cluster 820 (with just a single instance) and cluster 840 (with two instances) are considered candidate outlier clusters, and the corresponding instances are considered candidate outlier instances. Such candidate outlier clusters may typically be located towards extremities of a range of metric values.

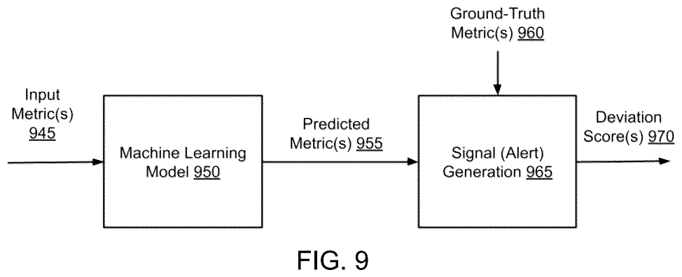

FIG. 9 is a block diagram that depicts determination of a load (traffic) based anomaly detection score, in accordance with some implementations.

Load based outliers may be determined by verifying that application level metrics for an application are commensurate with a load or traffic that is being handled by the application. For example, it may be determined whether a relatively high value for one or more metrics for an application, e.g., CPU utilization, is caused mainly by high levels of traffic, e.g., a long weekend holiday for an application serving streaming content to users, high shopping days such as Black Friday for an ecommerce application, etc.

For each application being monitored, corresponding input metrics are determined. This may vary from application to application, and may include metrics such as user traffic, incoming requests, etc. Input metrics may be autodetected or may be specified by a user, monitoring system, etc., or may be auto detected by the cloud management system based on an analysis of time-series data for different metrics, and a determination of which metrics of a set of metrics are largely driven by external factors.

For each application being monitored, input metric data 945 for one or more input metrics is provided to a trained machine learning (ML) model 950. As described earlier, a current value of the input metric(s) may be determined by adjusting for any time-delays in received time-series data of the input metric(s).

Based on the provided input metric(s), the ML model generates a predicted metric value 955 for one or more metrics for that application. In some implementations, a time-series prediction technique may be utilized by the ML model for estimating the metrics. The one or more metrics can include multiple metrics that are monitored for the application, and can include primary metrics, secondary metrics, value metrics, etc.

The predicted metric values for the one or more metrics are compared to actual metric values (ground-truth metrics) 960 at a signal (alert) generation module 965. Based on the comparison, one or more deviation score(s) 970 and/or severity scores are generated based on a relative normalized deviation of the predicted and ground-truth metric values. The normalization may be performed based on a determined standard deviation or variation observed for the corresponding metric(s). Other meta-data may also be determined by the ML model and provided to the alert generation module.

The ground truth metric values and input metric values are associated with a post release time period, e.g., a second time period or a third time period, whereas the predicted metric values are based on a pre-release ML and/or mathematical model.

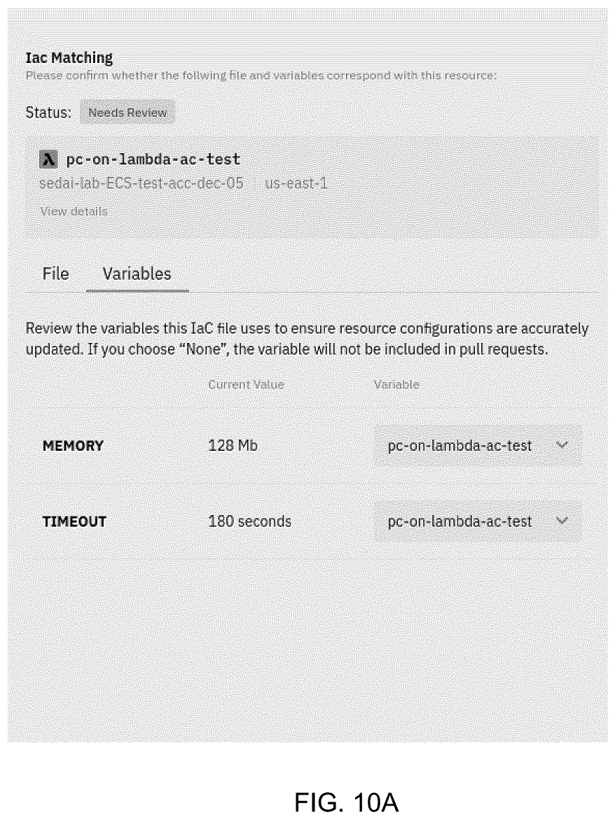

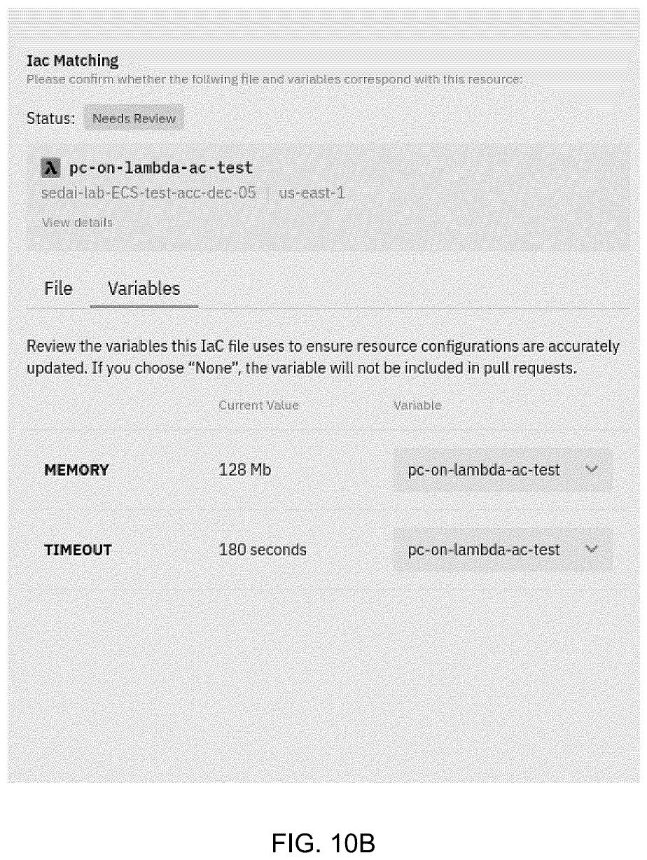

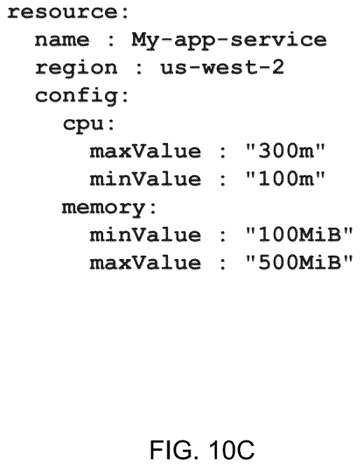

FIG. 10A-B depicts example screenshots of IaC synchronization, in accordance with some implementations.

FIG. 10C depicts an example guardrail configuration file that includes a specification of ranges of values for computing attributes, in accordance with some implementations.

As depicted in FIG. 10C, the guardrail configuration file includes specification of allowable ranges for CPU and memory. The resource is identified, and an upper bound (max Value) and lower bound (min Value) is provided for CPU and memory. During optimization, it is ensured that any settings for the computing attributes (CPU and memory, in this example) lie between the bounds specified in the guardrail configuration file.

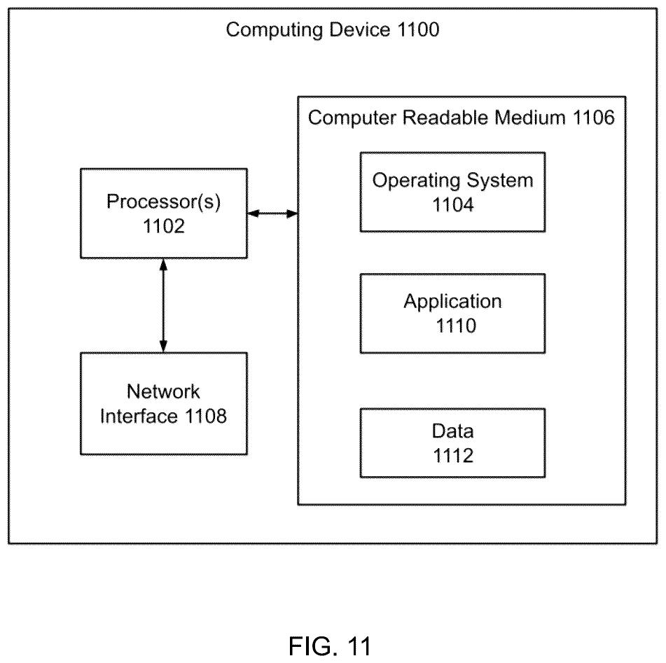

FIG. 11 is a block diagram of an example computing device 1100 which may be used to implement one or more features described herein. In one example, device 1100 may be used to implement a computer device (e.g. 110, 130, 140, 150, and/or 160 of FIG. 1), and perform appropriate method implementations described herein. Computing device 1100 can be any suitable computer system, server, or other electronic or hardware device. For example, the computing device 1100 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1100 includes a processor 1102, a memory 1104, input/output (I/O) interface 1106, and audio/video input/output devices 1114.

Processor 1102 can be one or more processors and/or processing circuits to execute program code and control basic operations of the device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Computer readable medium (memory) 1106 is typically provided in device 1100 for access by the processor 1102, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1104 can store software operating on the server device 1100 by the processor 1102, including an operating system 1104, one or more applications 1110 and application data 1112. In some implementations, application 1110 can include instructions that enable processor 1102 to perform the functions (or control the functions of) described herein, e.g., some or all of the methods described with respect to FIG. 5.

Elements of software in memory 1106 can alternatively be stored on any other suitable storage location or computer-readable medium. In addition, memory 1106 (and/or other connected storage device(s)) can store instructions and data used in the features described herein. Memory 1106 and any other type of storage (magnetic disk, optical disk, magnetic tape, or other tangible media) can be considered “storage” or “storage devices.”

An I/O interface can provide functions to enable interfacing the server device 1100 with other systems and devices. For example, network communication devices, storage devices (e.g., memory and/or data store 120), and input/output devices can communicate via the interface. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 11 shows one block for processor 1102 and one block for memory 1106. These blocks may represent one or more processors or processing circuitries, operating systems, memories, I/O interfaces, applications, and/or software engines. In other implementations, device 1100 may not have all of the components shown and/or may have other elements including other types of elements instead of, or in addition to, those shown herein. While the processing system 130 is described as performing operations as described in some implementations herein, any suitable component or combination of components of processing system 130 or similar system, or any suitable processor or processors associated with such a system, may perform the operations described.

A user device can also implement and/or be used with features described herein. Example user devices can be computer devices including some similar components as the device 1100, e.g., processor(s) 1102, memory 1106, etc. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices, for example, can be connected to (or included in) the device 1100 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
performing an optimization of one or more computing resources in a distributed computing system;
determining, based on the optimization, that a setting of at least one computing resource of the one or more computing resources is to be adjusted;
determining that performing an adjustment to the at least one computing resource would cause a mismatch between a setting for the at least one computing resource in the distributed computing system and a corresponding setting stored in a version control repository for the at least one computing resource;
generating an updated configuration file, wherein the update configuration file is indicative of an adjusted setting for the at least one computing resource; and
transmitting a request to a version control system to add the updated configuration file to the version control repository.

2. The computer-implemented method of claim 1, further comprising verifying that the adjusted setting for the at least one computing resource lies within a corresponding range of values for the at least one computing resource included in a guardrail configuration file.

3. The computer-implemented method of claim 1, further comprising:
determining that there is no defined range of values for the one or more computing resources included within the version control repository; and
providing a user interface to enable a user to generate the range of values for the one or more computing resources for inclusion in a guardrail configuration file.

4. The computer-implemented method of claim 1, further comprising:
determining that there is no defined range of values for the one or more computing resources included within the version control repository;
calculating a range of values for the one or more computing resources; and
transmitting the range of values to the version control system for inclusion in a guardrail configuration file within the version control repository.

5. The computer-implemented method of claim 1, wherein the distributed computing system is configured using a container orchestration system.

6. The computer-implemented method of claim 5, wherein the updated configuration file is a patch file that includes one or more environment specific transformers and generators that can be utilized to modify resources associated with each environment in the distributed computing system.

7. The computer-implemented method of claim 1, wherein the distributed computing system is configured using a cloud infrastructure provisioning system.

8. The computer-implemented method of claim 7, wherein the updated configuration file is operable to modify an override file that can be utilized to redeclare the at least one computing resource with an adjusted setting.

9. The computer-implemented method of claim 1, further comprising: merging the updated configuration file into the version control repository.

10. The computer-implemented method of claim 1, further comprising applying updated configuration settings to the distributed computing system.

11. A computer-implemented method, comprising:
receiving, at a version control system, a request from an autonomous cloud resource management system, wherein the request includes an updated configuration file that includes one or more updated configuration settings for a distributed computing system; and
merging the updated configuration file included in the request into a version control repository, wherein the version control repository includes a guardrail configuration file, and wherein the updated configuration file included in the request includes a setting for a resource attribute associated with one at least one computing resource that lies within specified values included in the guardrail configuration file.

12. The computer-implemented method of claim 11, further comprising generating the guardrail configuration file.

13. The computer-implemented method of claim 12, wherein generating the guardrail configuration file comprises generating the guardrail configuration file based on suggested values received from the autonomous cloud resource management system.

14. The computer-implemented method of claim 11, wherein the updated configuration file is operable to modify an override file that can be utilized to redeclare the at least one computing resource with an adjusted setting included in the one or more updated configuration settings.

15. The computer-implemented method of claim 11, wherein the updated configuration file is a patch file that includes one or more environment specific transformers and generators that can be utilized to modify resources associated with each environment in the distributed computing system.

16. The computer-implemented method of claim 11, further comprising applying the updated configuration file to the distributed computing system.

17. A system for integrating autonomous computing resource optimization with Infrastructure-as-Code (IaC) workflows, the system comprising:
an optimization engine configured to autonomously optimize computing resources in a live environment and to determine updated configuration settings for the live environment; and
a reconciliation module configured to:
detect a mismatch between a live environment configuration and a configuration defined in a version control repository resulting from the autonomous optimization; and
generate a request to the version control repository, the request including an additive configuration file that reflects the updated configuration settings.

18. The system of claim 17, wherein the live environment is a cluster of containers, and wherein the additive configuration file is a configuration patch file.

19. The system of claim 17, further comprising a custom provider configured to map resource addresses to corresponding cloud resource identifiers (IDs) and securely transmit the map to the system.

20. The system of claim 19, wherein the reconciliation module is configured to generate the request with an override file that redeclares the optimized resource with new attribute values.
